(19) United States
(12) Patent Application Publication
(10) Pub. No.: US 2009/0273669 A1
(43) Pub. Date: Nov. 5, 2009

(54) METHOD AND SYSTEM FOR DETECTING CRITICAL DEFECTS

(76) Inventors: Nadav WERTSMAN, Ein Hod (IL); Michael Lev, Yokneam (IL)

Correspondence Address: Pearl Cohen Zedek Latzer, LLP, 1500 Broadway, 12th Floor, New York, NY, 10036, US

(21) Appl. No.: 12/432,780

(22) Filed: Apr. 30, 2009

Related U.S. Application Data
(60) Provisional application No. 61/048,957, filed on Apr. 30, 2008.

(51) Int. Cl. G06K 9/00; H04N 7/18

(52) U.S. Cl. 348/87; 382/149; 382/224; 348/E07.085

(57) ABSTRACT

A system and method for evaluating a criticality of a defect. The method may include: obtaining information indicative of at least one spatial relationship between at least one inspected pattern of a layer of a micro-electronic device and an inspected defect; and determining a criticality of the detected defect in response to the obtained information and in response to at least one rule that associates between a criticality of a defect and a spatial relationship between the defect and at least one edge of at least one pattern of a layer of a micro-electronic device.

### CROSS REFERENCE TO RELATED APPLICATIONS

This application claims the benefit of U.S. Provisional Patent Application No. 61/048,957, filed on Apr. 30, 2008, which is incorporated in its entirety herein by reference.

### FIELD OF THE INVENTION

The present invention relates to a defect inspection method and system for micro-electronic devices during the manufacture of integrated circuits.

### BACKGROUND OF THE INVENTION

The process of manufacturing integrated circuits (chips) includes many process steps. Each process step is performed by multi-disciplinary equipment and, hence, is subject to systematic and random defects. Chipmakers who understand the need to inspect silicon micro-electronic devices, in order to identify defects and eliminate their root causes, routinely place inspection systems on production lines. These systems can simply indicate that defects exist at specific locations, or they can capture defect images and measure certain characteristics of the captured defects. Inspection-system vendors face growing challenges in view of the tight design rules and smaller dimension devices of advanced new production process technologies (process nodes) introduced by the various silicon foundries. State-of-the-art defect inspection systems, that are capable of detecting large numbers of defects, present a significant challenge of defining which defects are critical and, hence, require the disposal of the inspected micro-electronic device (wafer, die, etc.).

Introduction of advanced process nodes by the various silicon foundries also requires faster yield-learning cycles, that are key to helping chipmakers identify, analyze and fix manufacturing process problems of integrated circuits which ultimately limit yields and profitability. These problems can occur at both mask making and wafer fabrication stages. Wafer inspection is critical to accelerating yield learning by providing chipmakers with the capability to pinpoint failures within the device at each step in the manufacturing process, instead of waiting until final test. This is also critical in qualifying advanced production processes, which require chipmakers to capture all defect types and then separate the critical yield-killing defects from the rest of the captured defect population.

Today's high-sensitivity inline inspection solutions include: (A) a measurement (image acquisition) tool (Optical, Dark field, Bright Field, etc.), which captures the image of the inspected target; (B) an inspection tool which, based on known references, detects defects in the inspected target from the captured image, typically a large number of defects in a short time; (C) a review and classification tool (such as a Scanning Electron Microscope), which performs characterization and analysis of the captured defects; and (D) a management tool, which performs operational steps (e.g. disposing of wafers), according to inputs from the review and classification tool.

Measurement and inspection tools are commonly configured into a single inspection system. The image processing that is required for such classification tasks can be executed by a stand alone review and classification system that receives images of the captured defects from the companion inspection system and classifies them, or internally in a single inspection and classification system. Management tools are usually configured as stand alone management systems.

As defect review and classification tools have a considerably lower throughput compared to inspection tools, it is difficult to achieve an effective classification of defects on a full wafer with conventional tools, using the full data set of defects detected by the inspection tool. Accordingly, smart defect classification is required, by which the entire set of captured defects is reviewed and analyzed with the objective of identifying the various systematic and random defects that may be part of every manufacturing process step and are determined to be critical. Such defects include structural defects, in which patterns are faulty (e.g. defects like intrusion, protrusion, etc.), topographical defects (defects of a 3D nature, such as defects involving trenches, or particles on top of patterns, etc.); spatial defects, in which wafers have clusters of defects in certain locations; and material defects, which include defects caused by foreign material on the micro-electronic device.

Random defects are typically topographical or spatial defects that occur randomly on different layers and in different locations on each layer, one possible cause of which could be particles. Pattern defects are typically structural defects that can include missing material in a defined pattern or extraneous material not intended as part of a defined pattern, one possible cause of which could be a faulty mask set. Systematic defects are structural or spatial defects recurring consistently in the same relative layer and location in each chip, one possible cause of which could be a fault in a manufacturing process step.

Conventional review and classification systems automatically classify the captured defects by shape, size, density or material composition. However, the practicality of these systems is limited, due to inspection throughput requirements in view of high device complexities and consequent large numbers of detected defects.

One such system is disclosed in U.S. Pat. No. 6,922,482 (Ben-Porath). This patent describes a method and apparatus for automatically classifying a defect on the surface of a semiconductor wafer into one of a predetermined number of core classes using a core classifier employing boundary and topographical information. The defect is then further classified into a subclass of arbitrarily defined defects defined by the user with a specific adaptive classifier associated with the one core class and trained to classify defects only from a limited number of related core classes. Defects that cannot be classified by the core classifier or the specific adaptive classifiers are classified by a full classifier. The throughput of this apparatus is limited due to its two-step mode of operation, and also due to its reliance on SEM inspection equipment, which produces images of the inspected target top layer only.

Accordingly, there is a long felt need for a fast and a robust definition of defect criticality that will facilitate higher efficiency inspection, review and classification.

### SUMMARY OF EMBODIMENTS OF THE INVENTION

A method for evaluating a criticality of a defect, the method includes: obtaining information indicative of at least one spatial relationship between at least one inspected pattern of a layer of a micro-electronic device and a detected defect; and determining a criticality of the detected defect in response to the obtained information and in response to at least one rule that associates between a criticality of a defect and a spatial relationship between the defect and at least one edge of at least one pattern of a layer of a micro-electronic device.

A system for evaluating a criticality of a defect, the system includes: an information obtainer for obtaining information indicative of at least one spatial relationship between at least one inspected pattern of a layer of a micro-electronic device and an inspected defect; and a classifier for determining a criticality of the detected defect in response to the obtained information and in response to at least one rule that associates between a criticality of a defect and a spatial relationship between the defect and at least one edge of at least one pattern of a layer of a micro-electronic device.

### BRIEF DESCRIPTION OF THE DRAWINGS

The subject matter regarded as an embodiment of the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flow chart illustrating a method for detecting critical defects, according to one embodiment of the invention;

FIG. 2 is an illustration of a portion of a micro-electronic device with various pattern elements and defects;

FIG. 3 is a block diagram illustration of a system for detecting critical defects, constructed and operative in accordance with one embodiment of the invention;

FIG. 4 is a flow chart illustrating a method for detecting critical defects, according to one embodiment of the invention; and

FIG. 5 is a block diagram illustration of a system for detecting critical defects, constructed and operative in accordance with one embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention relates to a defect inspection and classification system and method for integrated circuit manufacturing, applicable to micro-electronic devices (such as but not limited to printed circuit boards, semiconductor chips, memory chips, logic, micro-processors, analog chips, mixed signal chips, CMOS image sensors, CCD, MEMS, and photo-voltaic cells). The system is based on classification of defects according to their criticality as determined by predefined rule sets concerning the relationship between defects and pattern edges. For purposes of the present invention, a “defect” can be a deviation from an expected pattern on the micro-electronic device, a particle that is at least partially located above a layer of a micro-electronic device, a scratch and the like. The particle can be partially included within the layer. The parameters of the rule sets are selected in accordance with design requirements of each silicon foundry and process node therein, and may be formulated, for example, using specific DRC (Design Rules Check) rules for the particular foundry/process node. These higher efficiency review and classification tools enable inspection solutions that result in enhanced yield of inspected circuits and faster operation of the inspection process.

There is provided according to one embodiment of the invention, a method for inspecting integrated circuits during manufacture, i.e., at the wafer or die form, the method including a predefined rule set for identifying and classifying detected structural defects, topographical defects and spatial defects according to their criticality, for each Silicon foundry process node and the related specific DRC.

In another embodiment of the invention, additional rules/limitation of rules include analyzing the specific process step at which the inspection is performed. As some portions of layers may be removed in subsequent process steps, detected defects located on those portions may become irrelevant and, thus, can be ruled as non critical defects.

In yet another embodiment of the invention, indicators whether a defect is critical/not critical are provided, which a management tool can use for such tasks as wafer disposal, or other wafer sorting or binning tasks.

There is also provided, according to another embodiment of the invention, a system for inspecting integrated circuits during manufacture, the system including an inspection tool and a defect review and classification tool, utilizing a plurality of predefined defect criticality rules. Under these rules, both random and systematic defects and are detected based on spatial and topographical relationships between defects and pattern edges and a particular process node DRC, and include: the number of edges a defect crosses, the type of edges a defect crosses, the direction of the edges defects cross, the location of a defect within a minimum distance from an edge of a pattern, and a defect touching an edge of a pattern. For example, the direction of a pattern edge that a defect crosses, can be of importance, for example in case of electro-migration in metal lines under high current densities where the relative orientation of the pattern and the defect can be critical to device performance. Yet for another example, the distance of a defect from a pattern edge can be evaluated in relation to the device design rules.

The present invention relates to inspection and classification of micro-electronic devices, particularly wafers or dies, in the course of integrated circuit manufacturing processes, which implements a classification system and method that provide a rapid analysis and indication of criticality of manufacturing defects, based on rules defining the relationship between the defects and pattern edges on the device. An inspection system, including an image acquisition tool, detects and collects the full set of defect data, and analyzes the data in order to identify critical systematic and random defects.

It will be appreciated that defects may have different sizes and shapes. However, the criticality of the defects can vary significantly, even for defects with identical size and shape, depending on their location. Defect criticality, according to the invention, is determined by their spatial and topographical relationship with respect to the surrounding patterns of the micro-electronic device.

It is noted that the criticality of defects can be evaluated during or after one or more stages of the manufacturing process of a micro-electronic device. Hence-the term micro-electronic device is not limited to the final micro-electronic device but rather applies to any combination of layers of the micro-electronic device that are manufactured by any stage of the manufacturing process of devices such as but not limited to, memory, logic, micro-processors, analog, mixed signal, CMOS image sensor, CCD, MEMS and photo-voltaic cells.

According to the present invention, the criticality of defects is determined by examining at least one of the following rules or a combination thereof—the rules define the relationship between a defect and one or more patterns on the inspected device: (i) the number of pattern edges a defect crosses, (ii) the type of pattern edges a defect crosses, (iii) the direction of the pattern edges a defect crosses, (iv) the distance of a defect from a pattern edge, (v) whether a defect touches a pattern edge,

It is noted that at least one of these mentioned above rules can be also responsive to at least one of the following: (i) the critical dimension of the pattern, (ii) process variation (expected or actual), (ii) the role (and/or importance) of patterns, and the like.

For example, if a certain pattern is critical to the functionality of a certain circuit of the micro-electronic device than a defect that crosses its edge can be more critical than a defect that crosses a pattern that is less important. The importance of a pattern can be learnt from the logical function it serves or, additionally or alternatively, from circuit design rules considerations.

As used in this application, edges are boundaries of the patterns on a wafer or a die, and are of different types based on whether they interface between two materials or structures or topographies. The direction of an edge on a wafer or a die is typically horizontal or vertical, as designated for different patterns and materials on different layers by a particular foundry process node.

For each silicon foundry and process node, a set of critical rules is selected based on one or more of the rules defined in (i) to (v) above, or combinations thereof, including specific foundry parameters, which can be based on specific DRC (Design Rules Check) rules for the particular foundry/process node and the tolerances they are willing to allow (trading off chip yields). These foundry specific rules are used for classification of defects according to their criticality for that specific process node. It will be appreciated that default parameters can, alternatively, be utilized. According to one embodiment of the invention, a binary decision can be provided, indicating whether a defect is critical for the device yield or not.

It is noted that according to another embodiment of the invention the decision can be a non-binary decision—for example a criticality grade can be assigned to each defect—whereas more than two possible grades can be provided. Yet for another example the criticality grade can be associated with a probability factor that indicates what is the probability that the defect is critical. The criticality grade can be affected from information obtained from previous inspections of one or more other micro-electronic device and can be responsive to tests (such as electrical tests, functionality tests) that evaluate the functionality of micro-electronic circuits. Preferably, these parameter sets can be modified and/or expanded, in real time.

Because the apparatus for implementing an embodiment of the present invention is, for the most part, composed of electronic components and circuits known to those skilled in the art, circuit details will not be explained to any greater extent than that considered necessary for the understanding and appreciation of the underlying concepts of the present invention and in order not to obfuscate or distract from the teachings of the present invention.

In the following specification, the invention will be described with reference to specific examples of embodiments of the invention. It will, however, be evident that various modifications and changes may be made therein without departing from the broader spirit and scope of the invention as set forth in the appended claims.

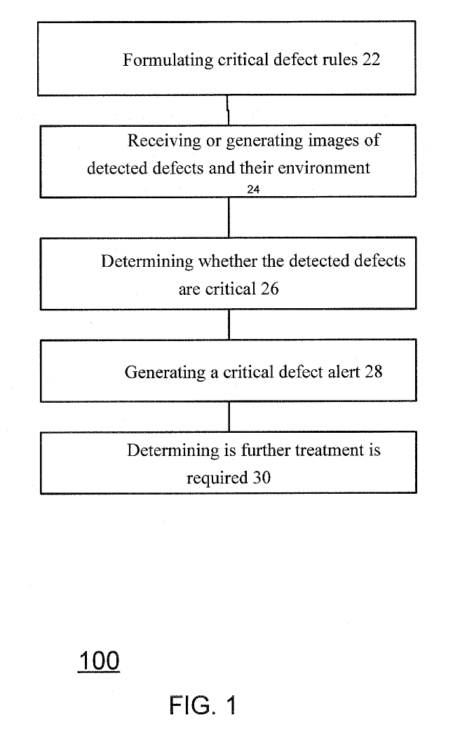

Referring now to FIG. 1, there is shown a flow chart illustrating one embodiment of a method 100 for detecting critical defects, according to the present invention.

Method 100 can start by stage 22 of formulating rules (also referred to as critical defect rules) for defining critical defects in accordance with the requirements of each silicon foundry process node. These rules are selected from the topographical, structural and spatial rules regarding defects and their surrounding pattern edges, as discussed above, and incorporate the parameters of each process node.

Stage 22 can be followed by stage 24 of generating or receiving images of defects and their environment. This can involve inspecting a micro-electronic device and capturing images or one or more areas of the micro-electronic device. These images, including suspected defects and their vicinity, can be captured by any known means. The images to be processed can be acquired optically or by any other method, such as ion microscopy or electron microscopy, using conventional methods and techniques, such as, but not limited to bright field, dark field, pulsed illumination, line scanning, and the like. The image processing that is required for such classification tasks can be executed by a stand alone review and classification system, that receives images of the captured defects from the inspection system and classifies them, or preferably, internally in a single integrated inspection and classification system.

Stage 24 is followed by stage 26 of determining (based upon the mentioned above critical defect rules and acquired images) whether the detected defects are critical defects, by applying the predefined critical defect rules including the foundry specific parameters, for the purpose of identifying problematic relationships between defects and the edges of surrounding patterns, which are critical to functionality of the finished device. The predefined rules are applied to data extracted from the captured images of each defect, and a defect that fulfills one or more rules is defined as being a critical defect.

Stage 26 can be followed by stage 24 of receiving or generating other images of detected defects and their environment. Stage 26 can also be followed by stage 28 of generating a critical defect alert—if one or more detected defect is a critical one. Stage 26 can be followed by stage 24 if, for example, the detected defect is not critical.

Stage 26 can provide a binary decision (whether the detected defect is critical or not) and stage 28 can include a binary decision indicator, signaling whether a detected defect is critical or not.

The binary decision indicator (or any other non-binary decision indicator that can be generated during stage 26) can be used in the process of pinpointing and analyzing failures within a device at each step in the manufacturing process, for fixing manufacturing process problems and improving yields and profitability. It can also be used in the process of wafer screening as an indicator showing that a critical defect exists and, thus, the wafer should be discarded.

Method 100 can also include stage 30 of determining whether further treatment is required. The further treatment can be triggered by finding one or more critical defects.

Stage 30 can be preceded by stage 26 or stage 28. FIG. 1 illustrates the latter option.

Stage 30 can be followed by another stage (now shown) of performing another treatment. For example—moving a micro-electronic device that has a critical defect to a special location for such purposes as disposal, further analysis or possible repair.

If desired, facilities (e.g., a management system) can be provided, for performing operational steps (e.g., binning or disposing of critically defective wafers), according to inputs from the inspection and classification system.

It will be appreciated that the method of detecting critical defects of the present invention can be implemented in a computer program product that includes a computer readable medium that stores instructions. When these instructions are executed by a computer, they cause the computer to execute the described method.

This method of critical defects classification is applicable to many inspection technologies (Optical, SEM, etc.) and is particularly advantageous in association with optical inspection systems which can detect images of a plurality of wafers' layers (i.e., when the layers are substantially transparent). Since the method and rule sets of this invention also include topographical defects involving 3D relationships, they can take advantage of optically generated multi-layer images, requiring fewer inline inspections compared to SEM generated images, which view only the top layer under inspection.

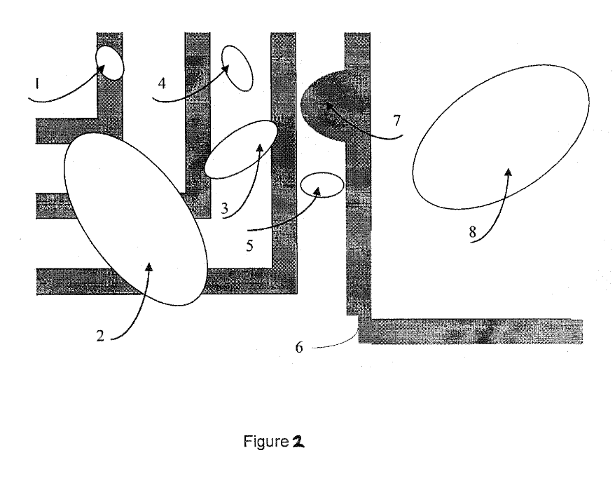

FIG. 2 illustrates a micro-electronic device, such as a wafer, having various defects numbered from 1 to 8. Examples of criticality rules, as applied to the defects shown in FIG. 2, are illustrated in, but not limited to, the following sample rules:

Sample rule I: When at least two pattern edge features are discontinued by a defect, the defect is critical. For example: defect number 2, which crosses 10 pattern edges, and defect number 3, which crosses 4 pattern edges, are critical under this rule, while defects numbers 8 and 4, which do not cross any pattern edge, are not.

Sample rule II: Defects that are close to at least one pattern edge—close in the sense of being within in a minimal predefined distance X (distance X can be a parameter set by the foundry or by another entity) from a pattern edge are critical. For example, defects numbers 4 and 7 are critical under this rule, since the distance between one edge of the defect and an edge of the nearest pattern is smaller than X.

Sample rule III: Defects having at least two edges at a distance from the nearest pattern edge that is below a pre-defined threshold, a parameter set according to a particular process node's design rule, are critical. For example, defect number 5 is closer to two edges of the device pattern than the relevant design rule distance, and defect number 1 is touching the two nearest pattern edges. Thus, these two defects are critical under this rule.

Sample rule IV: Defects which cross one or more edges of a pattern and which are closer than a predefined distance, as defined by the specific foundry and process node, to another edge of a pattern. In this case, a critical defect is one that crosses one edge of the pattern correlating to rule I and is too near to another edge as defined by rule II. For example: defects number 6 and 7 are critical under this rule since both of them violate rule I in one edge and rule II at another edge.

Additional rules can be formulated by inserting the foundry parameters into the rules defined in (i) to (v) above, or combinations thereof.

According to one embodiment of the invention, violations of the sample rules, in particular random defects, such as in cases 1, 2, 3, 4, 5 and 8 in FIG. 2 and others, may be further classified based on the specific layer and the specific step of the process at which the inspection is performed. Some defects that violate a predefined rule at a certain process step would be indicated as critical. However, these defects may be part of a portion of a layer that is removed in a subsequent process step and, thus, will be ruled as non critical.

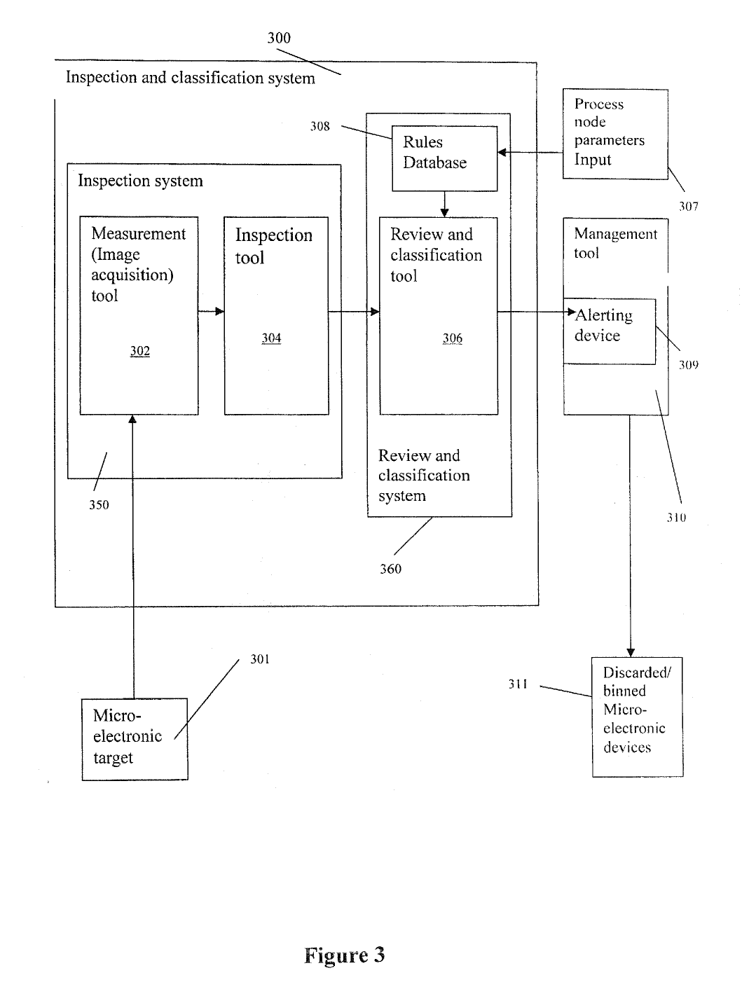

There is also provided, according to another embodiment of the invention, a system 300 for inspecting integrated circuits during manufacture, illustrated in block diagram form in FIG. 3. System 300 includes an integrated inspection system 350 and review and classification system 360. Inspection system 350 includes a measurement tool 302, for acquiring one or more images (such as image 303) of one or more areas of a layer of a micro-electronic device 301 and an inspection tool 304. Measurement tool 302 may include any known means, such as, optical, ion microscopy, electron microscopy or others, for capturing images of devices being inspected. It can also use conventional techniques, such as, but not limited to bright field, dark field, pulsed illumination, line scanning, and the like. Inspection tool 304 includes an image processor to extract the full data of detected defects 305 from the captured image 303, e.g., based on known references, typically a large number of defects in a short time.

Review and classification system 350 can include a defect review and classification tool, coupled to inspection tool 304, and a database 308 of critical defect rules. An input device 307 is coupled to database 308 to permit input of specific foundry process node parameters for generating the defect criticality rules stored in database 308. Defect review and classification tool 306 includes an image processor for performing the image processing tasks that are required for characterization and analysis of defects in the captured images, by applying the predefined critical defect rules in database 308. In this way, relationships between defects and the edges of surrounding patterns, which are critical to functionality of the finished device, can be identified.

According to one embodiment of the invention, an alerting device 309 is provided, coupled to review and classification system 360, for generating a critical defect alert signaling when a detected defect is critical. Alerting device 309 can provide an audible alarm and/or a visible indication of the status of the defect, as desired. Alternatively, or in addition, the output indication of criticality can be used by a management system 310, for performing operational steps (e.g., binning or disposing of critically defective wafers 311), if desired. Such indications can also be used for post processing of information related to wafers' critical defects, for statistical and other yield analysis.

According to another embodiment of the invention, review and classification system 350 is a stand alone system that includes a defect review and classification tool containing the image processor required for performing defect review and classification tasks. In this case, review and classification system 350 receives images of devices to be inspected captured by an external inspection tool.

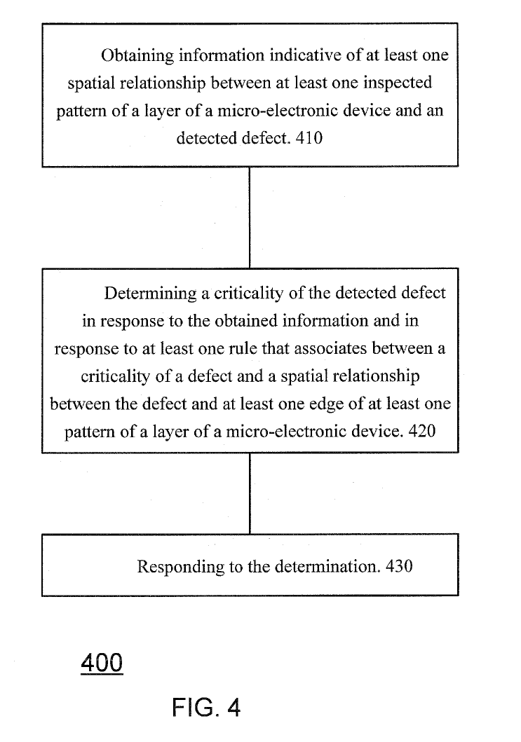

FIG. 4 illustrates method 400 for evaluating a criticality of a defect, according to an embodiment of the invention.

Method 400 starts by stage 410 of obtaining information indicative of at least one spatial relationship between at least one inspected pattern of a layer of a micro-electronic device and a detected defect.

Stage 410 can include at least one of the following stages or a combination thereof: (i) optically obtaining images of one or more areas of one or more layers of a micro-electronic device, during or after one or more manufacturing stages; (ii) obtaining images of one or more region of a layer by an inspection tool (that can use Bright field, Dark Field, DIC or Confocal techniques), detecting detected defects (or suspected detected defects); (iii) obtaining images of detected defects by a review tool such as a Scanning Electron Microscope, Electronic Beam Inspection tools (including multiple beam inspection tools) or optical tools (that can use Bright field, Dark Field, DIC or Confocal techniques); (iv) analyzing one or more images to provide spatial relationship information; (v) receiving electronic information representative of the spatial relationship from another tool or device.

Stage 410 is followed by stage 420 of determining a criticality of the detected defect in response to the obtained information and in response to at least one rule that associates between a criticality of a defect and a spatial relationship between the defect and at least one edge of at least one pattern of a layer of a micro-electronic device.

The at least one rules can be determined in advance, can be updated in real time or off-line or can be defined after some defects have been evaluated.

Method 420 can involve determining the criticality of the detected defect in response to at least one of the following rules or a combination thereof: (i) a rule that associates between the criticality of the defect and a number of pattern edges that the defect crosses; (ii) a rule that associates between the criticality of the defect and a type of at least one pattern edge that the defect crosses; (iii) a rule that associates between the criticality of the defect and a direction of at least one pattern edge a defect crosses; (iv) a rule that associates between the criticality of the defect and a number of pattern edges from which the defect is within up to a minimal distance; (v) a rule that associates between the criticality of the defect and a type of at least one pattern edge from which the defect is within up to a minimal distance; (vi) a rule that associates between the criticality of the defect and a direction of at least one pattern edge from which the defect is within up to a minimal distance.

Stage 420 can include at least one of the following stages: (i) determining that the detected defect is critical if it crosses multiple pattern edges; (ii) determining that the detected defect is critical if it crosses edges of different patterns; (iii) determining that the detected defect is critical if it within up to a minimal distance from edges of two different patterns; (iv) determining that the detected defect is critical if at least two pattern edges are discontinued by the detected defect; (v) determining the criticality of the detected defect in response to an importance of a pattern which is within up to a minimal distance from the detected defect; (vi) determining the criticality of the detected defect in response to an importance of a pattern that has an edge that is crossed by the detected defect.

Stage 420 is followed by stage 430 of responding to the determination made during stage 420.

Stage 430 can include at least one of the following stages or a combination thereof: (i) providing an indication about a criticality of the detected defect; (ii) generating an alert in response to a detection of a critical detected defect; (iii) printing an alert indicator; (iv) generating a report such as a critical defect map, (v) printing a report such as a critical defect map, (vi) displaying a report such as critical defect map; (vii) generating critical defect statistics, (viii) evaluating an accuracy of a rule based upon previous evaluations; (ix) evaluating an accuracy of a rule based upon electrical tests or other functional tests conducted on one or more micro-electronic devices, and the like.

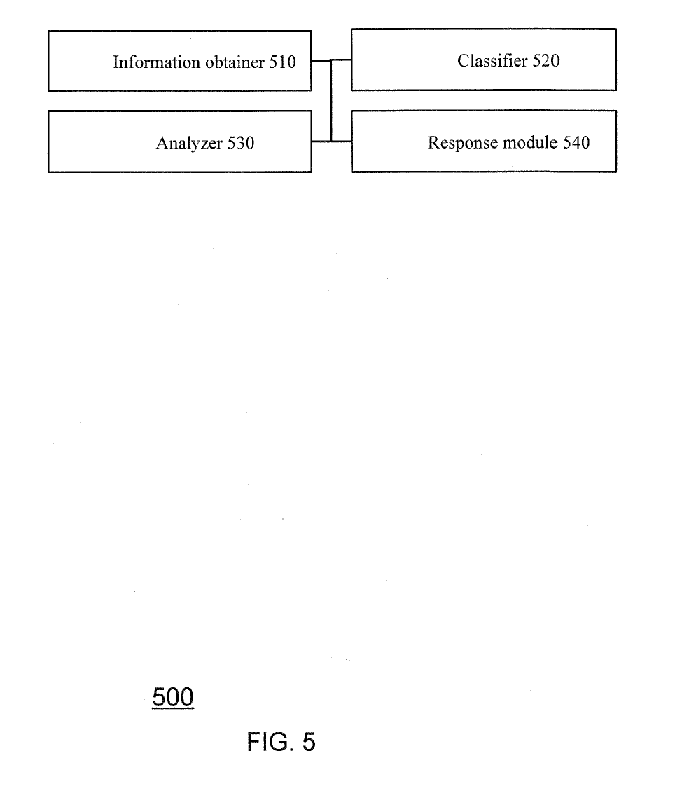

FIG. 5 illustrates system 500 according to an embodiment of the invention. System 500 includes information obtainer 510, classifier 520 and can include analyzer 530 and additionally or alternatively response module 540.

System 500 can optically acquire images of one or more areas of a layer of a micro-electronic device but this is not necessarily so. It can be a system that merely receives such information from an inspection tool or a defect review tool. It can be a stand alone system such as a computer or a server.

Information obtainer 510 obtains information indicative of at least one spatial relationship between at least one inspected pattern of a layer of a micro-electronic device and a detected defect. It can include hardware and software components or a combination thereof. It can include an interface and a memory unit that receives information. It can also include optical image acquisition units and can optically obtain images.

Classifier 520 determines a criticality of the detected defect in response to the obtained information and in response to at least one rule that associates between a criticality of a defect and a spatial relationship between the defect and at least one edge of at least one pattern of a layer of a micro-electronic device.

Classifier 520 can perform at least one of the following stages or a combination thereof: (i) determine the criticality of the detected defect in response to a rule that associates between the criticality of the defect and a number of pattern edges that the defect crosses; (ii) determine the criticality of the detected defect in response to a rule that associates between the criticality of the defect and a type of at least one pattern edge that the defect crosses; (iii) determine the criticality of the detected defect in response to a rule that associates between the criticality of the defect and a direction of at least one pattern edge a defect crosses; (iv) determine the criticality of the detected defect in response to a rule that associates between the criticality of the defect and a number of pattern edges from which the defect is within up to a minimal distance; (v) determine the criticality of the detected defect in response to a rule that associates between the criticality of the defect and a type of at least one pattern edge from which the defect is within up to a minimal distance; (vi) determine the criticality of the detected defect in response to a rule that associates between the criticality of the defect and a direction of at least one pattern edge from which the defect is within up to a minimal distance; (vii) determine that the detected defect is critical if it crosses multiple pattern edges; (viii) determine that the detected defect is critical if it crosses edges of different patterns; (ix) determine that the detected defect is critical if it within up to a minimal distance from edges of two different patterns; (x) determine that the detected defect is critical if at least two pattern edges are discontinued by the detected defect; (xi) determine the criticality of the detected defect in response to an importance of a pattern which is within up to a minimal distance from the detected defect; and (xii) determine the criticality of the detected defect in response to an importance of a pattern that has an edge that is crossed by the detected defect.

Analyzer 530 can analyze an image of an area of the micro-electronic device to determine the spatial relationship between the at least one inspected pattern of the layer of the micro-electronic device and the detected defect.

System 500 can also include a response module (not shown) that can respond to the determination made by classifier 520. Response module 540 can perform at least one of the following stages or a combination thereof: (i) provide an indication about a criticality of the detected defect; (ii) generate an alert in response to a detection of a critical detected defect; (iii) print an alert indicator; (iv) generate a report such as a critical defect map, (v) print a report such as a critical defect map, (vi) display a report such as critical defect map; (vii) generate critical defect statistics, (viii) evaluate an accuracy of a rule based upon previous evaluations; (ix) evaluate an accuracy of a rule based upon electrical tests or other functional tests conducted on one or more micro-electronic devices, and the like. Response module 540 can be a printer, a display, a computer, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for evaluating a criticality of a defect, the method comprising:
obtaining information indicative of at least one spatial relationship between at least one inspected pattern of a layer of a micro-electronic device and an inspected defect; and
determining a criticality of the detected defect in response to the obtained information and in response to at least one rule that associates between a criticality of a defect and a spatial relationship between the defect and at least one edge of at least one pattern of a layer of a micro-electronic device.

2. The method according to claim 1 comprising determining the criticality of the detected defect in response to a rule that associates between the criticality of the defect and a number of pattern edges that the defect crosses.

3. The method according to claim 1 comprising determining the criticality of the detected defect in response to a rule that associates between the criticality of the defect and a type of at least one pattern edge that the defect crosses.

4. The method according to claim 1 comprising determining the criticality of the detected defect in response to a rule that associates between the criticality of the defect and a direction of at least one pattern edge a defect crosses.

5. The method according to claim 1 comprising determining the criticality of the detected defect in response to a rule that associates between the criticality of the defect and a number of pattern edges from which the defect is within up to a minimal distance.

6. The method according to claim 1 comprising determining the criticality of the detected defect in response to a rule that associates between the criticality of the defect and a type of at least one pattern edge from which the defect is within up to a minimal distance.

7. The method according to claim 1 comprising determining the criticality of the detected defect in response to a rule that associates between the criticality of the defect and a direction of at least one pattern edge from which the defect is within up to a minimal distance.

8. The method according to claim 1 comprising determining the criticality of the detected defect in response to a rule that associates between the criticality of the defect and combination of at least two of the following parameters: (i) a number of pattern edges that the defect crosses; (ii) a type of at least one pattern edge that the defect crosses; (iii) a direction of at least one pattern edge a defect crosses.

9. The method according to claim 1 comprising determining the criticality of the detected defect in response to a rule that associates between the criticality of the defect and combination of at least two of the following parameters: (i) a number of pattern edges from which the defect is within up to a minimal distance; (ii) a type of at least one pattern edge from which the defect is within up to a minimal distance; and (iii) a direction of at least one pattern edge from which the defect is within up to a minimal distance.

10. The method according to claim 1 comprising determining that the detected defect is critical if it crosses multiple pattern edges.

11. The method according to claim 1 comprising determining that the detected defect is critical if it crosses edges of different patterns.

12. The method according to claim 1 comprising determining that the detected defect is critical if it within up to a minimal distance from edges of two different patterns.

13. The method according to claim 1 comprising determining that the detected defect is critical if at least two pattern edges are discontinued by the detected defect.

14. The method according to claim 1 comprising determining the criticality of the detected defect in response to an importance of a pattern which is within up to a minimal distance from the detected defect.

15. The method according to claim 1 comprising determining the criticality of the detected defect in response to an importance of a pattern that has an edge that is crossed by the detected defect.

16. The method according to claim 1 comprising analyzing an image of an area of the micro-electronic device to determine the spatial relationship between the at least one inspected pattern of the layer of the micro-electronic device and the detected defect.

17. A system for evaluating a criticality of a defect, the system comprising:
an information obtainer for obtaining information indicative of at least one spatial relationship between at least one inspected pattern of a layer of a micro-electronic device and an inspected defect; and
a classifier for determining a criticality of the detected defect in response to the obtained information and in response to at least one rule that associates between a criticality of a defect and a spatial relationship between the defect and at least one edge of at least one pattern of a layer of a micro-electronic device.

18. The system according to claim 17 wherein the classifier determines the criticality of the detected defect in response to a rule that associates between the criticality of the defect and a number of pattern edges that the defect crosses.

19. The system according to claim 17 wherein the classifier determines the criticality of the detected defect in response to a rule that associates between the criticality of the defect and a type of at least one pattern edge that the defect crosses.

20. The system according to claim 17 wherein the classifier determines the criticality of the detected defect in response to a rule that associates between the criticality of the defect and a direction of at least one pattern edge a defect crosses.

21. The system according to claim 17 wherein the classifier determines the criticality of the detected defect in response to a rule that associates between the criticality of the defect and a number of pattern edges from which the defect is within up to a minimal distance.

22. The system according to claim 17 wherein the classifier determines the criticality of the detected defect in response to a rule that associates between the criticality of the defect and a type of at least one pattern edge from which the defect is within up to a minimal distance.

23. The system according to claim 17 wherein the classifier determines the criticality of the detected defect in response to a rule that associates between the criticality of the defect and a direction of at least one pattern edge from which the defect is within up to a minimal distance.

24. The system according to claim 17 wherein the classifier determines the criticality of the detected defect in response to a rule that associates between the criticality of the defect and combination of at least two of the following parameters: (i) a number of pattern edges that the defect crosses; (ii) a type of at least one pattern edge that the defect crosses; (iii) a direction of at least one pattern edge a defect crosses.

25. The system according to claim 17 wherein the classifier determines the criticality of the detected defect in response to a rule that associates between the criticality of the defect and combination of at least two of the following parameters: (i) a number of pattern edges from which the defect is within up to a minimal distance; (ii) a type of at least one pattern edge from which the defect is within up to a minimal distance; and (iii) a direction of at least one pattern edge from which the defect is within up to a minimal distance.

26. The system according to claim 17 wherein the classifier determines that the detected defect is critical if it crosses multiple pattern edges.

27. The system according to claim 17 wherein the classifier determines that the detected defect is critical if it crosses edges of different patterns.

28. The system according to claim 17 wherein the classifier determines that the detected defect is critical if it within up to a minimal distance from edges of two different patterns.

29. The system according to claim 17 wherein the classifier determines that the detected defect is critical if at least two pattern edges are discontinued by the detected defect.

30. The system according to claim 17 wherein the classifier determines the criticality of the detected defect in response to an importance of a pattern which is within up to a minimal distance from the detected defect.

31. The system according to claim 17 wherein the classifier determines the criticality of the detected defect in response to an importance of a pattern that has an edge that is crossed by the detected defect.

32. The system according to claim 17 comprising an analyzer that analyzes an image of an area of the micro-electronic device to determine the spatial relationship between the at least one inspected pattern of the layer of the micro-electronic device and the detected defect.
